(19) United States
(12) Patent Application Publication
(10) Pub. No.: US 2026/0305570 A1
(43) Pub. Date: Oct. 8, 2026

(54) ANIMAL WATERING SYSTEM

(71) Applicant: Aborder Products, Inc., Irving, TX (US)

(72) Inventor: Xuzhong Wang, Shenzhen (CN)

(21) Appl. No.: 19/636,593

(22) Filed: Apr. 1, 2026

(30) Foreign Application Priority Data
Apr. 2, 2025 (CN) 202520633685.7

(51) Int. Cl. A01K 7/02; B01D 29/23; B01D 35/027; B01D 35/30

(52) U.S. Cl. CPC A01K 7/025; B01D 29/23; B01D 35/027; B01D 35/30; B01D 2201/302; B01D 2201/316

(57) ABSTRACT

An animal watering system may define and utilize a fluid pathway that extends from a fluid pump to a nozzle through a filter portion. The fluid pump may be positioned in a tank portion and the filter portion may be nested in a first tray portion that is positioned atop the tank portion. The nozzle may be attached to a second tray portion that is positioned atop the first tray portion. The filter portion may position a filter assembly to surround less than all the fluid pathway.

### CROSS-REFERENCE TO RELATED APPLICATIONS

This non-provisional application claims the benefit of CN Patent Application Ser. No. 202520633685.7 filed on Apr. 2, 2025, the disclosure of which is incorporated herein by reference in its entirety.

### FIELD OF THE DISCLOSURE

The present disclosure generally relates to pet devices, and more specifically to a pet watering device having a relatively simple construction that allows for continuous recirculation and filtering of water for a pet.

### BACKGROUND

As greater numbers of animals are kept as pets, increased amounts of time may be consumed providing care. For instance, maintaining sufficient volumes of fluid for pet consumption may become tedious in situations where multiple pets are present. The maintenance of sufficient volumes of fluid may become inefficient with some fluid retention equipment, such as a bowl, pail, bucket, or other receptacle, that may be susceptible to spilling. Additionally, fluid retention equipment that maintains fluid in a stagnant state may be susceptible to contamination. With these issues in mind, some fluid retention equipment may be arranged with electronic components that circulate fluid over time, which may mitigate contamination.

Some pet watering devices may utilize an electronic pump to circulate fluid have gained popularity for maintaining water freshness. However, some devices may suffer from several drawbacks, such as fluid levels within the device being difficult to observe when refilling is necessary. For instance, a conduit connecting a fluid pump to the fluid outlet may be cumbersome to install, or remove, which may complicate cleaning. Furthermore, some fluid filtration structures may offer limited effectiveness. It is contemplated that impurities may easily clog a provided filter, which may degrade water quality and circulation. Additionally, the installation and replacement of fluid filters may often not be efficient or user-friendly.

Therefore, there is a need for an improved animal watering system that provides a structure with enhanced filtration along with greater ease of use and maintenance.

### SUMMARY

Embodiments of the present disclosure may provide an animal watering system, and associated components, that provides optimized replacement and use. In order to provide a basic understanding of the present disclosure, a simplified overview of some embodiments of the present disclosure is given below. The overview is not limiting to the present disclosure and is intended to identify elements.

In accordance with various embodiments, an animal watering system may have a tank portion, a fluid pump, a first tray portion, a second tray portion, a filter portion, and a nozzle portion. The fluid pump may be positioned within the tank portion and the first tray portion may be positioned atop the tank portion. The filter portion may be nested in the first tray portion and the second tray portion may be positioned atop the tank portion. The nozzle portion may extend from the second tray portion with a fluid pathway continuously extending from the fluid pump to the nozzle via the filter portion. The fluid pathway may pass through the first tray portion and the second tray portion without contacting the first tray portion and/or the second tray portion.

An animal watering system, in some embodiments, defines and utilizes a fluid pathway that extends from a fluid pump to a nozzle through a filter portion. The fluid pump may be positioned in a tank portion and the filter portion may be nested in a first tray portion that is positioned atop the tank portion. The nozzle may be attached to a second tray portion that is positioned atop the first tray portion. The filter portion may position a filter assembly to surround less than all the fluid pathway.

Embodiments of an animal watering system may operate by depositing a fluid in a tank portion prior to passing the fluid from the tank portion to a filter portion via a fluid pump with the filter portion nested in a first tray portion and the first tray portion positioned atop the tank portion. The fluid may be delivered to a second tray portion via a nozzle that is in fluid communication with the fluid pump via a fluid pathway extending through the filter portion and first tray portion. Once the second tray portion is removed from the first tray portion, the filter portion may be separated from the first tray portion without removing the first tray portion from the tank portion. At least one filter medium of a filter assembly contained within a filter housing of the filter portion may be replace before inserting the filter portion in a filter hole of the first tray portion to align a standpipe portion of the filter housing with an outlet of the fluid pump. The second tray portion may be placed onto the first tray portion to align a receiving conduit of the second tray portion with the standpipe portion and then the nozzle may be installed into the receiving conduit to form the fluid pathway that is utilized to flow fluid from the tank portion to the second tray portion.

### BRIEF DESCRIPTION OF THE DRAWINGS

For a more complete understanding of this disclosure, reference is now made to the following description, taken in conjunction with the accompanying drawings, in which:

FIG. 1 is a perspective view line representation of aspects of an animal watering system in which assorted embodiments of the present disclosure may be practiced.

FIG. 2 is a partially exploded perspective view of portions of the animal watering system of FIG. 1 arranged in accordance with various embodiments.

FIG. 3 is a cross-sectional view along line A-A of the animal watering system of FIG. 1 configured in accordance with some embodiments.

FIG. 4 is a partially exploded perspective view of aspects of the animal watering system of FIG. 1 that may be utilized in accordance with assorted embodiments.

FIG. 5 is a perspective view line representation of portions of the animal watering system of FIG. 4 arranged in accordance with various embodiments.

FIG. 6 is a top view of aspects of the animal watering system of FIG. 5 configured in accordance with some embodiments.

FIG. 7 is a cross-sectional view along line B-B of the animal watering system of FIG. 6 utilized in accordance with assorted embodiments.

### DETAILED DESCRIPTION

Embodiments of the present disclosure are generally directed to an animal watering system arranged with filtering configurations that may provide optimized use and maintenance.

In the following description, different embodiments of the present disclosure will be described. For purposes of explanation, particular structures and details are presented to provide a thorough understanding of the embodiments. However, for those skilled in the art the present disclosure can be realized without the need for specific details. In addition, well-known features will be omitted or simplified for clarity of the described embodiments.

While the use of electro-mechanical pumps to cycle fluid to, and from, a fluid reservoir have been generally employed to service a diverse variety of applications and industries, the consistent flow of fluid over time may present challenges. For instance, contaminates and debris may become entrapped in a fluid and degrade the quality, and safety, of the fluid for consumption. The presence of a fluid filter in combination with a fluid pump may mitigate some risk of fluid impurities from jeopardizing the quality and safety of fluid, but may present operational challenges in the form of filter access and replacement. Hence, various embodiments are generally directed to an animal watering system providing a filtering assembly configured to provide optimized use and maintenance to provide heightened fluid quality and safety.

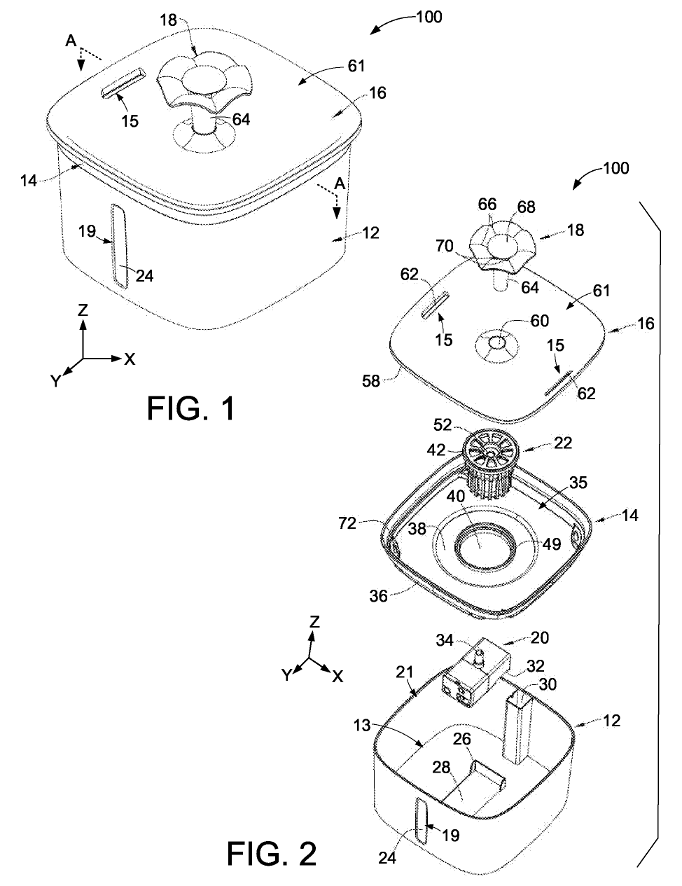

In FIGS. 1-7, various views display aspects of an animal watering system 100 configured and operated in accordance with assorted embodiments. The perspective view of the animal watering system 100 in FIG. 1 conveys an assembled and operational configuration where a water tank 12, which may be arranged to hold one or more fluids in some embodiments, engages a first tray portion 14. A second tray portion 16 is positioned atop the first tray portion 14 and presents a nozzle 18 for fluid dispensing. In operation, fluid from the nozzle 18 is collected by the second tray portion 16 for consumption by an animal, such as a dog, cat, or bird.

Embodiments of the animal watering system 100 may configure the second tray portion 16 to retain a predetermined volume of fluid over time as fluid flows onto the second tray portion 16 from the nozzle 18 and drains from the second tray portion 16 by one or more drain apertures 15. The first tray portion 14 may be configured to collect fluid from a drain aperture 15 and direct fluid to a filter portion 22 and to a fluid reservoir 13 defined by the water tank 12, as shown in FIG. 2. The volume of fluid retained in the water tank 12 may be examined by accessing one or more level portions 19, which may be arranged as a visual and/or mechanical indicator of where a fluid level resides with respect to the sidewalls of the water tank 12.

A partially exploded view of the animal watering system 100 is shown in FIG. 2. In accordance with assorted embodiments, the water tank 12 has a closed bottom and an open top, along the Z axis, defined by a continuous sidewall to define the fluid reservoir 13 conducive to retaining fluid, such as water, without leaking. Access to the fluid reservoir 13 may be provided by a top opening 21 and a level portion 19.

Embodiments of the level portion 19 may provide a viewing window 24 that may be transparent, or partially opaque, to reveal the volume of fluid in the tank 12 via visual inspection. Although the window 24 may be provided on a sidewall of the water tank 12 for observing the water level, some embodiments may provide a fluid volume indicator, such as a mechanical gage, meter, or scale, that operates without visual access into the fluid reservoir 13.

To move fluid such as water from the water tank 12 to the nozzle 18, one or more electro-mechanical pumps 20 may be employed. For reference, the electro-mechanical pump 20 is also sometimes referred to as a pump, a water pump, and a fluid pump. While the pump 20 may be powered by a battery source, various embodiments provide electrical power via a wired connection. However, providing electrical wires to the pump 20 may present areas of increased risk of leaking when passing into the water tank 12. Additionally, the pump 20 may move, float, or re-position within the water tank 12, which may pose operational challenges to getting fluid to the nozzle 18 for dispensing to the second tray portion 16.

With these issues in mind, the water tank 12 may be arranged with one or more positioning blocks 26 that define a positioning nest 28 on a bottom inside surface the water tank 12, as shown in FIG. 2. The water pump 20 may be detachably mounted to the bottom inside surface of the water tank 12 and fixed within the positioning nest 28, for example, by one or more attachment features, such as suction cups, hook-and-loop fasteners, or a dynamic mechanism, to allow secure positioning, reliable replacement, and selective inspection.

The sidewall of the water tank 12 may be arranged as shown with a cord portion 30 that defines a cord channel extending between the fluid reservoir 13 and a port to the exterior of the water tank 12. By extending the cord portion 30 to the top opening 21 of the water tank 12, electrical wires may pass to the pump 20 with mitigated risk of fluid leaking from the fluid reservoir 13. The connection of the pump 20 to electrical power via one or more electrical wires may allow for selective activation that moves fluid between a fluid inlet 32 and a fluid outlet 34 by creating differential pressure.

While not required or limiting, the first tray portion 14 may be configured to physically support a filter portion 22 and drain holes 72 that respectively guide fluid into the fluid reservoir 13. The first tray portion 14 may be a unitary component that has a size and shape to allow for detachable fitment with the sidewall of the water tank 12 to partially cover the top opening 21. That is, the first tray portion 14 may be configured to rest upon the sidewall of the water tank 12 with a flange portion 36 while providing fluid access to, and from, the fluid reservoir 13.

In accordance with some embodiments, the first tray portion 14 may be configured with a drainage pool portion 35 that collects fluid, such as water, and guides the fluid into the filter portion 22 until a predetermined volume of fluid accumulates in the pool portion 35 and fluid flow is initiated with one or more drain holes 72. That is, the filter portion 22 may be positioned lower, along the Z axis, than the drain holes 72 to promote fluid to pass through the filter portion 22 first and through the drain holes 72 after the pool portion 35 reaches a higher level.

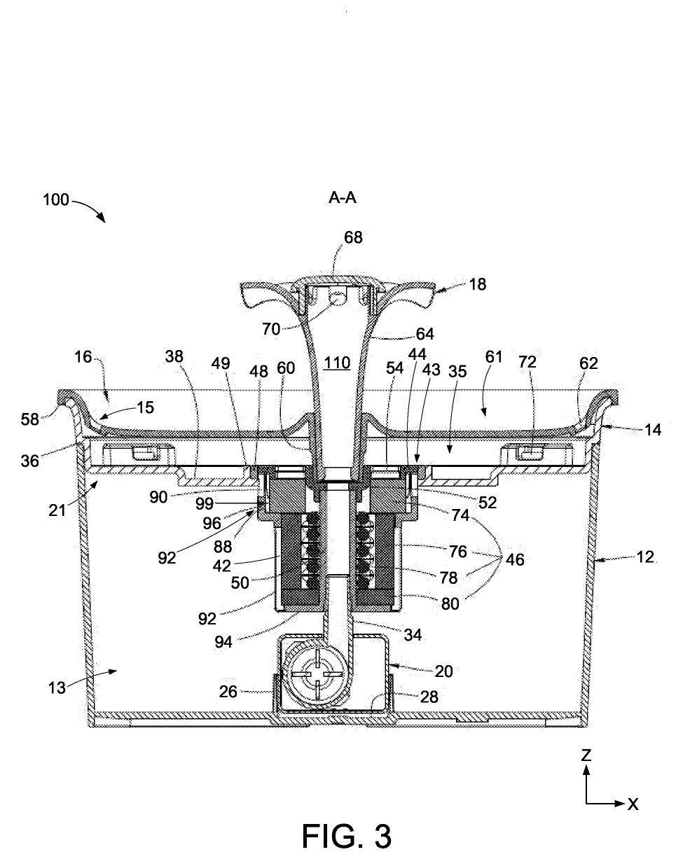

It is contemplated that the pool portion 35 is arranged as a planar, concave, curvilinear, or combination of linear and curvilinear surfaces to direct fluid towards the filter portion 22. As shown, the filter portion 22 may be configured to fit within an annular recess 38 and filter hole 40, which may present dynamic topography and elevation that promotes laminar fluid flow into the filter portion 22. In operation, the filter portion 22 may be inserted through the filter hole 40 along its axial direction, parallel to the Z axis, and positioned to protrude from the bottom of the annular recess 38 into the water tank 12, as illustrated in FIG. 3.

Embodiments of the second tray portion 16 may be detachably installed above the first tray portion 14. The second tray portion 16 may form a fitting flange 58 that connects, such as with a friction fit, snap-fit, or mechanical mechanism, onto the upper rim of the first tray portion 14. The second tray portion 16 may be formed in a generally concave shape, along the X-Y plane, with a downwardly extending receiving conduit 60 provided at a center region. An upper port of the receiving conduit 60, along the Z axis, may be formed, in some embodiments, of planar, semi-planar, or curvilinear surfaces that may form an umbrella shape, generally, on the upper surface of the second tray portion 16. A lower port of the receiving conduit 60 may be connected to the upper port of the lid conduit 52.

At least one return hole 62 may be present on the surface of the second tray portion 16, allowing fluid on the second tray portion 16 to flow to the first tray portion 14. The configuration of fluid return holes 62 extending through the second tray portion 16 may be collectively characterized as drain apertures 15 that may operate individually, and collectively to return fluid to the water tank 12 via the filter portion 22.

Assorted embodiments of the nozzle 18 may provide a selectably detachable component installed into the receiving conduit 60 of the second tray portion 16. The nozzle 18 may have a downwardly extending riser pipe 64 that is configured to be inserted into the upper port of the receiving conduit 60 of the second tray portion 16 to form a fluidic pathway from the water tank 12 to a dispensing portion 61 defined by the second tray portion 16. While the nozzle 18 may be arranged with any number, and type, of fluid delivery to the dispensing portion 61, some embodiments may provide multiple separate flow guide channels 66 that communicate with a fluid shield portion 68 to provide a flow of a predetermined volume of fluid to the dispensing portion 61. It is contemplated that the guide channels 66 and shield portion 68 are configured to provide an aesthetically pleasing design, reduce wind-induced leakage of fluid, or laminar fluid flow from the riser pipe 64 to the dispensing portion 61.

The non-limiting embodiment of the nozzle 18 shown in FIG. 2 provides a plurality of flow guide channels 66 surrounding the upper port of the riser pipe 64. The riser pipe 64 further conveys the water discharged from the receiving conduit 60 upward, which then flows out via the flow guide channels 66 and falls back into the second tray portion 16. The shield portion 68 may cooperates with the upper port of the riser pipe 64 to form a plurality of spray ports 70 corresponding to the flow guide channels 66 so that fluid passed upward from the riser pipe 64 is blocked by the shield portion 68 and then flows out from the spray ports 70 into the flow guide channels 66.

Through the assembly of the components shown in FIG. 2 to form the animal watering system 100 shown in FIG. 1, fluid may be continually circulated. For instance, the pump 20 may activate to convey water from inside the water tank 12 upward, sequentially flowing through the standpipe portion 50, the lid conduit 52, the receiving conduit 60, and the riser pipe 64, then falling onto the dispensing portion 61 of the second tray portion 16 along the flow guide channels 66 to provide sufficient water for pets to consume. The second tray portion 16 may be arranged so that when the water level in the second tray portion 16 rises above the return holes 62 in the dispensing portion 61, water flows from the return holes 62 to the first tray portion 14.

Some impurities carried in the water settle in the annular recess 38 under gravity, while another portion of the impurities, along with the water, passes over the annular filter ridge 49 and enters the filter portion 22 from the inlet 54, which may include a plurality of separate holes, apertures, or channels. Fluid filtered by the filter portion 22 may then flow out from the outlet 56 of the filter housing 42, which may include a plurality of separate holes, apertures, or channels, into the water tank 12 to be able to re-enter the water pump 20 and achieving fluid circulation. As a result of the configuration of the filter portion 22, Impurities in the fluid may be substantially retained at the first tray portion 14 and the filter portion 22. The function of the annular filter ridge 49 may block impurities settled on the first tray portion 14 from entering the water tank 12 through the filter hole 40 when the filter portion 22 is removed from the filter hole 40.

Once in the pool portion 35, which is defined by the first tray portion 14, fluid may accumulate above a predetermined volume, and height along the Z axis, so that flow is initiated in at least one drain hole 72 to pass water into the reservoir 13 of the water tank 12. The height of the drain hole 72 above the pool portion 35 may be positioned to be at least higher than the inlet 54 of the filter portion 22 so that water returning to the first tray portion 14 preferentially enters the filter portion 22 through the inlet 54. When the filter portion 22 may become clogged by impurities causing the water level in the first tray portion 14 to rise above the drain hole 72, water will flow directly back to the water tank 12 from the drain hole 72.

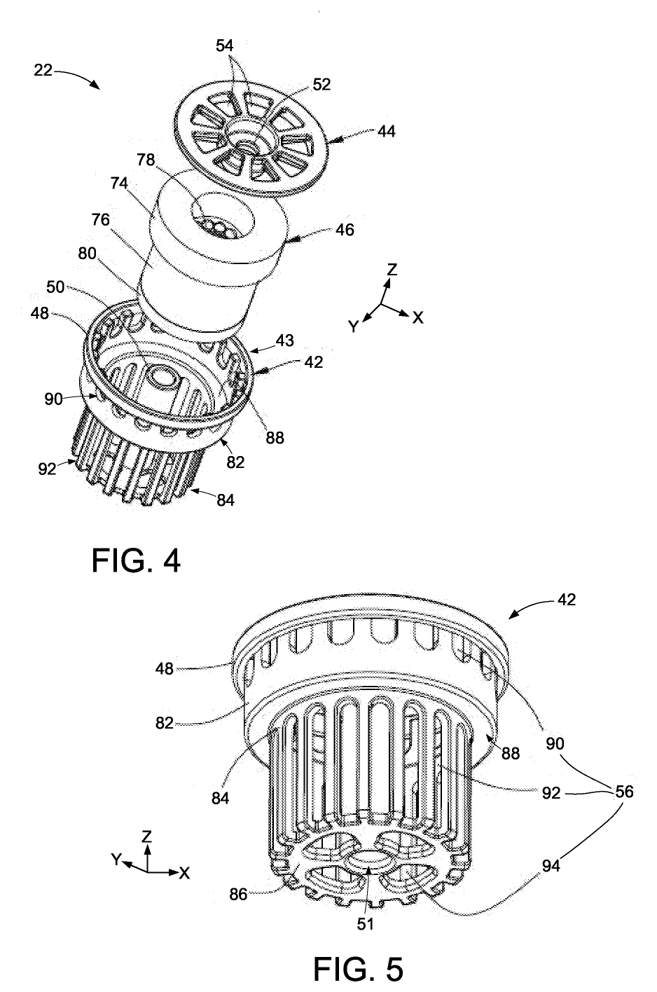

FIG. 3 provides a cross-sectional view of the animal watering system 100 along line A-A in FIG. 1. As shown in FIG. 3, some embodiments configure the filter portion 22 with a filter housing 42 that provides a standpipe portion 50 that may connect to the nozzle 18 on a first end and to the pump outlet 34 on an opposite second end 51 which may be a smaller, or larger, opening than the rest of the standpipe portion 50. Further aspects of the filter portion 22 are conveyed in FIGS. 4-7 as constructed and operated in accordance with various embodiments. While a single filter material, or structure, may be employed with the first tray portion 14 to remove impurities and contamination through the flow of fluid from the pool portion 35 through the filter hole 40 to the fluid reservoir 13, relatively simple filter arrangements may become easily clogged and/or dirty, which may intensify contamination of fluid being circulated by an animal watering system 100. Thus, embodiments of the filter portion 22 provide multiple filtering media that may provide enhanced flow, filtering, and replacement efficiency with the first tray portion 14 and the animal watering system 100.

As best viewed in FIGS. 3 and 4, a filter housing 42 is configured with a lid opening 43 sized to fit, and potentially retain, a filter lid 44 to receive and retain a filter assembly 46. In this way, a continuous fluid pathway 110 extends from the fluid pump 20 to the nozzle portion 18 by way of the outlet pipe 34 of the fluid pump 20, the standpipe portion 50 of the filter housing 42, the lid conduit 52 of the filter lid 44, and the riser pipe 64 of the nozzle 18. It is noted that the continuous fluid pathway 110 passes through the first tray portion 14 and the second tray portion 16, and is arranged so as to not contact at least the first tray portion. Other arrangements can be used, including arrangements in which the fluid pathway 110 does not contact the second tray portion as well.

Although not required or limiting, the filter housing 42 may be configured to present a number of separate fluid passages, such as holes, apertures, slots, and gaps, to allow fluid to pass into, and out of, the filter assembly 46. For instance, the filter housing 42 may be constructed of a rigid, semi-rigid, or flexible material that retains the filter assembly 46 while assorted fluid passages allow fluid to flow through the filter assembly 46 with a predetermined flow rate, as further illustrated in the perspective view of the filter housing 42 in FIG. 5.

Embodiments of the filter housing 42 may provide an annular flange 48 configured to receive and retain the filter lid 44 to position the lid conduit 52 in fluidic communication with the standpipe portion 50. As shown in the cross-sectional view of FIG. 3, the lid conduit 52 may engage the standpipe portion 50 and allow fluid to efficiently pass from the pump outlet 34 to the nozzle 18 with predetermined pressure and flow rate while maintaining the placement of the filter assembly 46 surrounding the standpipe portion 50. It is contemplated, but not required, that the filter lid 44 may attach to the annular flange 48, such as with snaps, friction tabs, or articulating levers.

Other embodiments of the filter lid 44 may engage and attach to portions of the first tray portion 14, such as the annular filter ridge 49 area of the filter hole 40. Regardless of whether the filter lid 44 attaches to the annular filter ridge 49, the annular recess 38 that surrounds the filter hole 40 may be configured with a lower elevation than the filter ridge 49, which may provide a concentration of fluid in the pool portion 35 around the filter portion 22 and optimize fluid flow into the filter assembly 46. That is, the annular filter ridge 49 may define a physical barrier between the annular recess 38 and the filter assembly 46 while securely supporting the filter portion 22 in fluidic communication with both the fluid reservoir 13, in a drainage flow direction, and the nozzle 18, in a dispensing flow direction. The annular filter ridge 49 may further provide a sealing surface with the annular flange 48, which may or may not have an intervening gasket or seal, to prevent fluid from passing from the pool portion 35 to the fluid reservoir 13 other than through the filter portion 22 and drain holes 72.

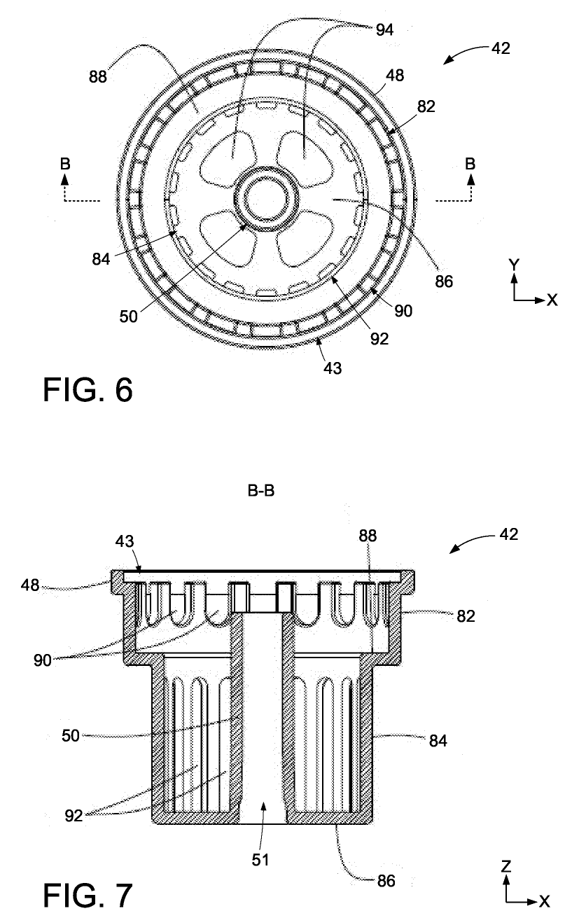

FIG. 7 provides a cross-sectional view of the filter housing 42 along line B-B in FIG. 6. As shown in FIG. 7, the standpipe portion 50 may be formed centrally inside the filter housing 42 and configured to extend from a position adjacent to the top opening of the filter housing 42 towards the bottom of the housing and through to the outside of the bottom of the filter housing 42. A lower port of the standpipe portion 50 may be connected to the water outlet pipe 34 of the water pump 20 with, or without, and an intervening coupler, fastener, or ring. Meanwhile, the opposite upper port of the standpipe portion 50 may be connected or otherwise fluidically coupled to the lid conduit 52.

In accordance with various embodiments, the filter assembly 46 may be wholly contained within the filter housing 42 and arranged to surround the periphery of the standpipe portion 50. The filter lid 44 is disposed over the top opening of the filter housing 42, thereby substantially enclosing the filter assembly 46. The outer wall of the filter housing 42 defines at least one outlet 56 so that fluid entering the filter portion 22 through the inlet 54 of the filter lid 44 passes through the filter assembly 46 and then flows out of the filter housing 42 from the outlet 56 into the water tank 12, which filters the fluid for impurities and/or contaminants.

In some embodiments, the animal watering system 100, and particularly the filter portion 22 may not employ the lid conduit 52 to physically, and fluidically, connect the standpipe portion 50 with the riser pipe 64 of the nozzle 18. For instance, the riser pipe 64 may pass through the filter lid 44 and couple directly to the standpipe portion 50 to create a continuous fluidic pathway 110 from the pump 20 to the spray ports 70 of the nozzle 18. It is noted that physical connection of the standpipe portion 50 and the riser pipe 64 may be arranged to be inside, or outside, the areal extent of the filter housing 42.

Embodiments of the animal watering system 100 may not incorporate the receiving conduit 60 of the second tray portion 16 into the continuous fluidic pathway 110 from the fluid reservoir 13 to the dispensing portion 61. For example, a through-hole may be formed at the center of the second tray portion 16 so that the riser pipe 64 may pass through the through-hole to directly connect to the standpipe portion 50, which may eliminate a sealed connection between the riser pipe 64 and receiving conduit 60 for efficient delivery of fluid from the nozzle 18.

With the first tray portion 14, various embodiments may configure the pool portion 35 to control the flow of fluid and the build-up of contaminants from the cycling fluid. That is, the first tray portion 14 may be arranged with one or more features, such as texture, topography, protrusions, grooves, ridges, or recesses, that may direct fluid towards the filter portion 22, generally, while promoting the settling of contaminants and debris in predetermined regions prior to entering the filter portion 22, which may increase the usable life and efficiency of the filter assembly 46. For instance, the pool portion 35 may have a varying topography configured to increase the chances of heavier contaminants, such as solids or sand, to rest and remain in designated regions of the pool portion 35 as fluid continues to flow from the pool portion into the fluid reservoir 13 via the filter portion 22 and drain holes 72. As a result, less fluid contaminates will pass through the filter portion 22 and the drain holes 72 and the remnant contaminates may be efficiently discarded with removal of the first tray portion 14 from the second tray portion 16.

The animal watering system 100, in some embodiments, may be configured without the nozzle 18 shown in FIGS. 1-3. Hence, fluid conveyed upward from the pump 20, through the filter standpipe portion 50, may flow directly out of the receiving conduit 60 to fill the dispensing portion 61 of the second tray portion 16 to provide sufficient volume of fluid for animals to efficiently drink. Just as the nozzle 18 may be removed without disabling the operation of fluid cycling, the second tray portion 16 may be selectively omitted, which would utilize the pool portion 35 to dispense fluid to animals for drinking purposes.

In FIGS. 3 and 4, the filter assembly 46 is shown incorporating four types of filter media. While not limiting or required, the filter media of the filter assembly 46 may be different materials, sizes, and/or shapes that are positioned in the filter housing 42 to provide a predetermined balance of fluidic flow rate through the filter portion 22 and filtering of fluid impurities. That is, the size, shape, and material of the assorted media of the filter assembly 46 may be selected and arranged to provide a designated flow rate into the fluid reservoir 13, such as flow rate that exceeds, or matches, the dispensing flow rate from the pump 20 to the nozzle 18, along with a designated filtration rate, such as maximum particle size allowed through the filter assembly 46 at the designated flow rate.

According to various embodiments, the filter assembly 46 may have a first filter medium 74, a second filter medium 76, a third filter medium 78, and a fourth filter medium 80 with the first filter medium 74 configured as a pre-filter/coarse-filter medium forming the first stage of filtration while the second filter medium 76, the third filter medium 78, and the fourth filter medium 80 are configured to provide main-filtration, or fine-filtration, forming the second stage of filtration.

As shown in the cross-sectional view of FIG. 3 and the partially exploded view of FIG. 4, the first filter medium 74 may be located in the upper part of the filter portion 22 for filtering larger-sized impurities, such as hair, food, or large sand particles, and may be, for example, a coarse-pore sponge with relatively large pores. The first filter medium 74 may be formed as a hollow cylinder, sleeved around the periphery of the standpipe portion 50 and the lid conduit 52 (if present) and covering the lid inlet 54, to ensure that all fluid entering from the lid inlet 54 passes through the first filter medium 74.

The second filter medium 76 may contact the first filter medium 74 and positioned downstream, towards the fluid reservoir 13, from the first filter medium 74, which may operate to adsorb impurities and remove odors or pigments, and may be, for example, a carbon rod made of activated carbon, formed as a hollow cylinder and sleeved around the periphery of the standpipe portion 50.

Some embodiments of the filter assembly 46 may provide a space between the inner surface of the second filter medium 76 and the outer surface of the standpipe portion 50, which is partially or completely filled with the third filter medium 78. Although not required, the third filter medium 78 may be configured to reduce fluid hardness or remove residual chlorine, and may be a granular material, such as resin filter media, mineral filter media, or calcium sulfite.

A fourth filter medium 80, in accordance with assorted embodiments, is located at the bottom of the filter housing 42, towards the pump 20 and fluid reservoir 13, and adjacent to the bottom of the second filter medium 76. The fourth filter medium 80 may, or may not, contact one or more of the second filter medium 76 and the third filter medium 78 and be configured for filtering smaller-sized impurities, such as fine sand, clay particles, or suspended particles. The fourth filter medium 80 may be, for example, a fine-pore sponge with relatively small pores. The fourth filter medium 80 may be formed as a hollow cylinder, sleeved around the periphery of the standpipe portion 50, with no gap between the fourth filter medium 80 and the standpipe portion 50, which may block the bottom of the second filter medium 76 and enclose the third filter medium 78 in the filter housing 42 to form the filter assembly 46.

While four filter media are incorporated into the filter assembly 46 to provide dual stage filtration of fluid, it is contemplated that the filter assembly 46 may have fewer than, or more than, four types of materials and may form more than two stages of filtration.

It is noted that the arrangement positions or shapes of the filter media in the filter assembly 46 at various levels may be adjusted as needed, but may generally follow the sequence from coarse filtration to fine filtration from the pool portion 35 to the fluid reservoir 13. As such, performing coarse filtration upstream of the fine filtration stages can extend the life of subsequent filter media. For example, the positions of the second filter medium 76 and the fourth filter medium 80 may be swapped within the filter housing 42, with corresponding adjustments to the shapes and/or sizes of the assorted media 74/76/78/80. It will be appreciated that the filter assembly 46 (e.g., media 74, 76, 78 and/or 80) can be arranged to fully surround the fluid pathway 110 as generally represented in FIG. 4, or can be arranged to only partially surround the fluid pathway as required.

The filter assembly 46, in some embodiments, may be packaged together as a single unit while other embodiments may allow the assorted media 74/76/78/80 to be loosely installed in the filter housing 42. Regardless of the construction and configuration of the filter assembly 46, the filter portion 22 may be reusable or disposable. When reusable, the filter lid 44 may detachable relative to the filter housing 42. When disposable, the filter lid 44 may be fixed in place relative to the filter housing 42, which may be facilitated by any number, and type, of joining methods, such as ultrasonic welding or adhesive bonding.

Continuing with reference to FIGS. 3-7, the outer wall of the filter housing 42 is configured with an upper wall 82, proximal the filter lid 44, a lower wall 84 positioned proximal the bottom of the filter housing 42, and a bottom wall 86 positioned at the bottom of the filter housing 42, along the Z axis. A junction between the upper wall 82 and the lower wall 84 may form an annular support 88 located inside the filter housing 42.

The annular support 88 may be configured to divide the filter portion 22 into filtration stages, such as a first-stage filtration located above the annular support 88 and a second-stage filtration located below the annular support 88, along the Z axis. The first filter medium 74 may serve as the first-stage filtration of the filter assembly 46 due to the upstream position relative to the second filter medium 76 and fourth filter medium 80. The annular support 88 may extend horizontally inward from the outer wall of the filter housing 42 at a predetermined orientation, such as at a right angle, parallel to the X-Y plane, or at a non-normal angle with respect to the X-Y plane.

The outlet 56 of the filter housing 42 may be configured with a first outlet 90 located on the upper wall 82, a second outlet 92 located on the lower wall 84, and a third outlet 94 located on the bottom wall 86. Embodiments of the first outlet 90 may position a lowest point to be higher than the highest point of the annular support 88, as shown in the cross-sectional profile of the filter portion 22 in FIG. 7. Thus, the portion 96 of the upper wall 82 located below the first outlet 90 connects with the annular support 88 to form a fluid guide member 98. Furthermore, the first filter medium 74 may be configured to have a gap 99 between its outer peripheral wall and the upper wall 82, as shown in FIG. 3.

In accordance with various embodiments, the filtration process of the filter portion 22 may pass a fluid, such as water, into the filter portion 22 through the inlet 54, and after being filtered by the first filter medium 74, the fluid may flow out along the outer peripheral wall, inner peripheral wall, and bottom wall of the first filter medium 74 to enter the second-stage filtration below the annular support 88. It is noted that fluid flowing along the outer peripheral wall of the filter housing 42 may fall into the water guide member 98 to be guided into the second-stage filtration, which may prevent fluid that has undergone the first-stage filtration from directly flowing out from the first outlet 90.

In the event the media of the second-stage filtration become clogged, causing the fluid level inside the filter portion 22 to rise above the first outlet 90, fluid will then flow back to the water tank 12 from the first outlet 90. Since the likelihood of clogging in the first-stage filtration is relatively low, this design ensures that fluid undergoes two-stage filtration during initial operation, and at least one-stage filtration during prolonged operation. It should be noted that to ensure all fluid undergoes two-stage filtration during initial operation, the water level inside the water tank 12 should not be higher than the first outlet 90.

Embodiments of the filter portion 22 may arrange the second outlet 92 and the third outlet 94 to serve both as outlets for the second-stage filtration and also retaining aspects to keep the fluid in the water tank 12 in constant contact with the second filter medium 76 or the fourth filter medium 80 to provide continuous adsorption and purification of the fluid in the tank 12. It is contemplated that one of the second outlet 92 and the third outlet 94 may not be provided, which may allow fluid to flow back to the water tank 12 through only one of these outlets after undergoing second-stage filtration. In some embodiments, the first outlet 90 may be omitted to ensure that water undergoes two-stage filtration under all circumstances. However, if the filter portion 22 becomes completely, fluid may be directed to flow directly back to the water tank 12 unfiltered through the overflow drain hole 72.

The animal watering device 100 provided in this embodiment offers many advantages over the prior art: water circulation turns "stagnant water" into "flowing water"; the first tray portion 14 can settle some impurities; it can perform multi-stage filtration on water; and it can maintain coarse filtration even if fine filtration fails.

It should be noted that the above specific embodiments are exemplary, and the person skilled in the art may come up with various solutions inspired by the disclosure of the present invention, and all of these solutions also fall within the scope of disclosure of the present invention and fall within the scope of protection of the present invention. The person skilled in the art should understand that the specification of the present invention and its accompanying drawings are illustrative and do not constitute a limitation of the claims. The scope of protection of the present invention is limited by the claims and their equivalents. The specification of the present invention contains a number of inventive ideas, such as "preferably", "alternative embodiments" or "optionally" means that the corresponding paragraph discloses an independent idea, and the applicant The applicant reserves the right to file a separate application based on each inventive concept. Throughout the text, the features guided by "preferably" are only optional and should not be construed as mandatory, so the applicant reserves the right to waive or delete the relevant preferred features at any time.

What is claimed is:

1. An animal watering system comprising:
a tank portion;
a fluid pump positioned within the tank portion;
a first tray portion positioned atop the tank portion;
a filter portion nested in the first tray portion;
a second tray portion positioned atop the first tray portion; and
a nozzle portion extending from the second tray portion, wherein a fluid pathway continuously extends from the fluid pump to the nozzle portion through the filter portion, the fluid pathway passing through the first tray portion and the second tray portion without contacting the first tray portion.

2. The animal watering system of claim 1, wherein the filter portion comprises a plurality of different filtering media supported within a filter housing.

3. The animal watering system of claim 1, wherein the filter portion comprises a filter housing and a filter lid which enclose at least one filtering medium, and wherein the fluid pathway comprises a standpipe portion of the filter housing which interconnects with an outlet pipe of the fluid pump and a lid conduit of the filter lid which interconnects with a riser pipe of the nozzle portion.

4. The animal watering system of claim 1, wherein the filter portion is configured to separate from the first tray portion while the first tray portion contacts the tank portion.

5. The animal watering system of claim 1, wherein the filter portion is configured to surround the fluid pathway.

6. An animal watering system comprising a fluid pathway extending from a fluid pump to a nozzle through a filter portion, the fluid pump positioned in a tank portion and the filter portion nested in a first tray portion positioned atop the tank portion, the nozzle attached to a second tray portion positioned atop the first tray portion, the filter portion positioning a filter assembly comprising at least one filtering medium to at least partially surround the fluid pathway.

7. The animal watering system of claim 6, wherein the filter portion is configured to suspend from a recess region of the first tray portion.

8. The animal watering system of claim 6, wherein the filter assembly comprises a plurality of different filter media each surrounding the fluid pathway.

9. The animal watering system of claim 6, wherein the filter assembly is configured to position a first filter medium between the tank portion and a pool portion defined by the first tray portion.

10. The animal watering system of claim 6, wherein a filter housing of the filter portion is configured with a first diameter and a second diameter, the second diameter being greater than the first diameter and extending from an annular support.

11. The animal watering system of claim 10, wherein the filter housing is configured with a plurality of outlets configured to surround the filter assembly.

12. The animal watering system of claim 6, wherein the filter portion comprises a filter housing and a filter lid which enclose the filter assembly, and wherein the fluid pathway comprises a standpipe portion of the filter housing which interconnects with an outlet pipe of the fluid pump and a lid conduit of the filter lid which interconnects with a riser pipe of the nozzle portion.

13. The animal watering system of claim 12, wherein the filter housing comprises a first plurality of outlets oriented substantially parallel to the fluid pathway, and wherein the filter lid comprises a second plurality of outlets oriented substantially perpendicular to the fluid pathway.

14. The animal watering system of claim 6, wherein the filter portion comprises a lid portion defining a lid conduit aligned with a standpipe portion of the filter housing and a riser pipe portion of the nozzle, wherein a portion of the second tray portion extends between the riser pipe portion of the nozzle and the lid conduit of the lid portion.

15. The animal watering system of claim 14, wherein the lid portion is configured to contact the filter housing to enclose the filter assembly.

16. The animal watering system of claim 6, wherein the filter portion is positioned below a plurality of drain holes in the first tray portion, each drain hole of the plurality of drain holes passing to a reservoir defined by the tank portion.

17. The animal watering system of claim 6, wherein the filter assembly fully surrounds the fluid pathway.

18. A method comprising:
depositing a fluid in a tank portion;
passing the fluid from the tank portion to a filter portion via a fluid pump, the filter portion nested in a first tray portion, the first tray portion positioned atop the tank portion;
delivering the fluid to a second tray portion via a nozzle, the nozzle in fluid communication with the fluid pump via a fluid pathway extending through the filter portion and first tray portion;
removing the second tray portion from the first tray portion;
separating the filter portion from the first tray portion without removing the first tray portion from the tank portion;
replacing at least one filter medium of a filter assembly contained within a filter housing of the filter portion;
inserting the filter portion in a filter hole of the first tray portion to align a standpipe portion of the filter housing with an outlet of the fluid pump;
placing the second tray portion onto the first tray portion to align a receiving conduit of the second tray portion with the standpipe portion;
installing the nozzle into the receiving conduit to form the fluid pathway; and
flowing fluid from the tank portion to the second tray portion via the fluid pathway.

19. The method of claim 18, wherein four different filter media of the filter assembly are respectively replaced prior to inserting the filter portion in the filter hole.

20. The method of claim 18, further comprising flowing fluid from the second tray portion to the first tray via a plurality of return holes prior to flowing fluid from the first tray portion to the tank portion through the filter portion.
